(19) United States
(12) Patent Application Publication
(10) Pub. No.: US 2009/0134798 A1
(43) Pub. Date: May 28, 2009

(54) DISCHARGE LAMP, ELECTRODE, AND METHOD OF MANUFACTURING AN ELECTRODE PORTION OF A DISCHARGE LAMP

(75) Inventors: Nina Huck, Eindhoven (NL); Erik Jacobus Marinus Houet, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,004

(22) PCT Filed: Oct. 28, 2005
(86) PCT No.: PCT/IB05/53520

§ 371 Date: Apr. 26, 2007

(30) Foreign Application Priority Data
Nov. 2, 2004 (EP) 04105461.0

(51) Int. Cl. H01J 61/06; H01J 9/02

(52) U.S. Cl. 313/631; 445/46

(57) ABSTRACT

The invention relates to a discharge lamp comprising a sealed transparent bulb accommodating two electrodes, wherein at least one of said electrodes has at least a porous portion comprising first particles with a first mean particle site (μ₁) defined by a first particle size distribution (11) and second particles (20) with a second mean particle size (μ₂) defined by a second particle size distribution (21). The first mean particle size (μ₁) is smaller than said second mean particle size (μ₂). Consequently, an electrode portion with a higher porosity and a longer lifetime is obtained.

The invention relates to a discharge lamp comprising a sealed bulb accommodating two electrodes, wherein at least one of said electrodes has at least a porous portion. The invention further relates to an electrode and a method of manufacturing an electrode portion of a discharge lamp.

Discharge lamps typically comprise two electrodes positioned opposite to each other in a sealed transparent or translucent bulb filled with gas. In operation, current is provided to these electrodes which results in a pronounced heating of the electrodes. Consequently, the thermal design of the electrodes in e.g. an ultra high pressure (UHP) or high intensity discharge (HID) lamp is an important issue in preventing an early failure of the lamps during operation.

One method to reduce the temperature effects on electrode life is to increase the surface area of the electrode. U.S. Pat. No. 6,218,025 discloses a sintered electrode of high-melting metal produced from spherical metal powder having a well-defined particle size. The mean particle size is from 5 μm to 70 μm. The particle size distribution covers a range from at most 20% below to at most 20% above the mean particle size. The residual porosity of the sintered electrode is 15-30% of the volume to be achieved.

A disadvantage of the electrode of the prior art is the difficulty of sintering said electrode to obtain a porous electrode, since the sintering time for large particles is long.

It is an object of the invention to provide a discharge lamp comprising a porous electrode that can be manufactured more easily.

This object is achieved by a discharge lamp comprising a sealed bulb accommodating two electrodes, wherein at least one of said electrodes has at least a porous portion comprising first particles with a first mean particle size defined by a first particle size distribution and second particles with a second mean particle size defined by a second particle size distribution, and wherein said first mean particle size is smaller than said second mean particle size.

This object is further achieved by a method of manufacturing an electrode portion for a discharge lamp, comprising the steps of:
providing a mixture of first particles with a first mean particle size defined by a first particle size distribution and second particles with a second mean particle size defined by a second particle size distribution, wherein said first mean particle size is smaller than said second mean particle size, and
sintering said mixture so as to obtain said electrode portion.

This object is also achieved by an electrode with at least a porous portion comprising first particles with a first mean particle size defined by a first particle size distribution and second particles with a second mean particle size defined by a second particle size distribution, wherein said first mean particle size is smaller than said second mean particle size.

According to the invention, at least two powders with significantly different mean particle sizes are mixed and sintered to obtain the electrode portions. In a particularly advantageous embodiment of the invention, the mean particle sizes differ by at least a factor five, preferably a factor ten. It has been observed that the smaller particles function as a sintering aid for the larger particles which are responsible for the residual porosity of the electrode portion. Consequently, an improved porous electrode portion is obtained within a reasonable sintering time.

The embodiment of the invention as defined in claims 3, 4 and 8 has the advantage that the porosity of the sintered product is in the range of 40-50% of the volume of the porous electrode portion.

The embodiment of the invention as defined in claims 5 and 9 has the advantage that the decrease in strength resulting from the porosity of the electrode portion can be mitigated in that the porous portion is only provided for a particular high-temperature portion of the electrode, while non-porous, and consequently stronger, parts, such as a rod, are used for the remaining portion of the electrode.

The embodiment of the invention as defined in claims 6 and 10 has the advantage that an interruption of the manufacturing process for the electrode portion at an appropriate stage after extrusion renders possible a reshaping before sintering. This is advantageous, for example, for connecting further parts, such as a rod, to the porous electrode portion. Furthermore, no expensive and complicated dedicated molds are required. Finally, extrusion allows the electrode material to contain a considerable amount of emitter material that can be reshaped in an appropriate reshaping process before sintering.

The invention will be further illustrated with reference to the attached drawings, which schematically shows a preferred embodiment according to the invention. It will be understood that the invention is not in any way restricted to this specific and preferred embodiment.

In the drawings:

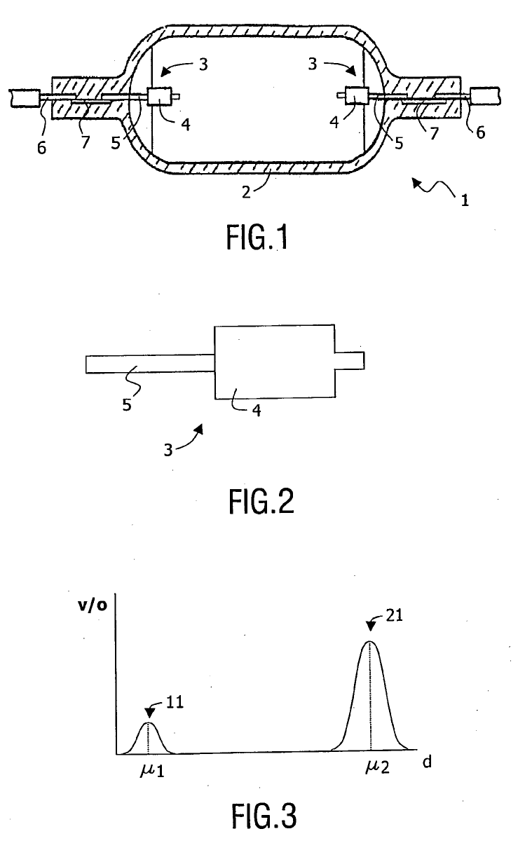

FIG. 1 diagrammatically shows an AC HID lamp;

FIG. 2 diagrammatically shows the electrode of FIG. 1 in an embodiment of the invention;

FIG. 3 shows an exemplary particle size diagram for a mixture for an electrode according to an embodiment of the invention;

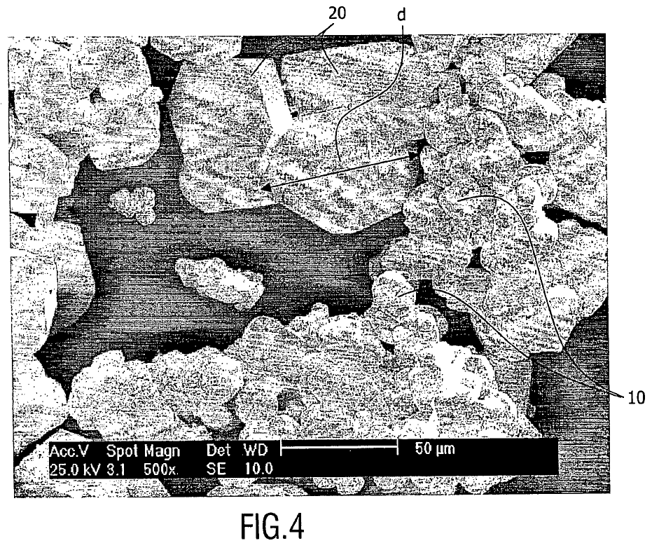

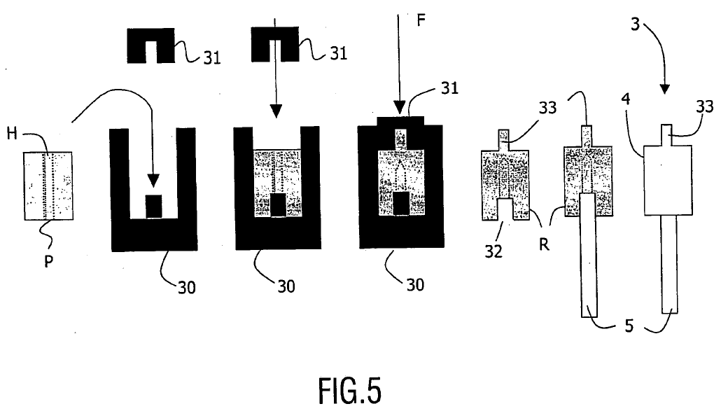

FIG. 4 shows a scanning electrode microscope image of an electrode portion according to an embodiment of the invention, and

FIG. 5 illustrates various manufacturing steps for obtaining the electrode portion of FIG. 2 according to an embodiment of the invention.

FIG. 1 shows an AC high intensity discharge (HID) lamp 1, hereinafter referred to as lamp 1. The lamp 1 has a sealed, transparent or translucent bulb 2 that forms a discharge chamber accommodating electrodes 3, each with a porous electrode portion 4 and an elongate portion 5, i.e. an electrode 3 with a well-defined electrode tip. Current can be fed to and from the electrodes 3 via leads 6 and feed-throughs 7. FIG. 2 shows a detailed image of the electrode 3, wherein the porous electrode portion 4 is a reshaped extruded cylindrical portion and the elongate portion 5 is a drawn rod.

FIG. 3 shows an exemplary particle size diagram of a mixture of material for obtaining the porous electrode portion 4 according to an embodiment of the invention. Vertically, the volume percentage of powder is presented and horizontally, the particle size d. FIG. 4 shows a scanning electrode microscope image of the portion 4 after sintering.

The porous portion 4 has first particles 10 with a first mean particle size A defined by a first particle size distribution 11 and second particles 20 with a second mean particle size 92 defied by a second particle size distribution 21. The first mean particle size μ₁ is smaller than said second mean particle size 2. As an example, the tungsten powder mixture WHC 400/4000 of H.C. Starek is provided with a volume ratio of 10 volume % of the first tungsten particles 10 with a mean particle size μ₁ of 4 μm and 90 volume % of second tungsten particles 20 with a mean particle size μ₂ of 40 μm. As is shown in FIG. 4, the smaller tungsten particles 10 function as a sintering aid for the second, larger particles 20.

The porous electrode portion 4 can be obtained by extrusion or metal injection molding (MIM). Extrusion involves the pressing of a mixture of a powder, a solvent, and a binder through a die to obtain an extruded product, followed by sintering of this product. MIM involves casting of a mixture with the refractory material in a mold that is specifically designed for the required shape of the electrode. The green product is subsequently sintered.

In a particularly advantageous embodiment of the invention, the porous electrode portion 4 is made by extrusion of a mixture with at least two mean particle sizes μ₁, μ₂, as indicated above, and a binder to obtain an extruded product P as shown in FIG. 5. The mixture may further include a solvent, such as an alcohol, and an electron emitter substance. This mixture is pressed through a die with a pin (not shown) to obtain an intermediate product. The solvent is subsequently removed so as to obtain a strong product that is appropriate to handle. The product in this stage is commonly referred to as the green product. The green product is cut into pieces of appropriate size to obtain the extruded product P. The extruded product has a through hole H caused by the pin of the extrusion die.

At this stage, one or more sintering steps, i.e. heating the extruded product to a temperature at which the powder particles merge with each other to obtain a fully dense product, are conventionally applied. According to the embodiment of FIG. 5, however, this process is interrupted by a reshaping step.

In the embodiment of FIG. 5, a solvent, such as an alcohol, is selectively added to the extruded product P in places where reshaping of the extruded product P is intended. The binder is temporarily weakened thereby. The positionally selective addition of the solvent is accomplished, for example, by dipping only the relevant portion of the extruded product P in the solvent.

Then, the weakened portion of the extruded product P is reshaped under pressure by reshaping tools 30, 31 generating a compression force F to obtain a reshaped extruded product R of tungsten with a recess 32 and a protrusion 33 for the porous portion 4 of the electrode 3. The solvent is subsequently removed from the reshaped extruded product R. A drawn rod 5 is then inserted into the recess 32 to obtain an electrode 3 with a well-defined electrode tip for a HID lamp 1. The rod 5 may also be manufactured by extrusion, which generally is a cleaner processing than wire drawing.

The conventional process of sintering is then resumed, comprising a pre-sintering step at a temperature of e.g. 1000-1200° C. to remove the binder from the reshaped extruded product R and a sintering step at 2000-2600° C. to obtain the porous portion 4 for the electrode 3 of FIG. 1. The rod 5 is fixed in the recess 33 by sinter shrinking of the porous portion 4.

The discharge lamp according to the invention has an electrode portion 4 with a porosity in the range of 40-50% of the volume of the portion 4. The surface roughness Ra is 5.5 μm when the powder WHC 400/4000 is used. By comparison, a powder such as HC40S of Starck typically yields a surface roughness Ra of 0.5 μm. Surface roughness is measured, for example, optically or with a scanning surface tip. The porous electrode portion 4 of the invention increases the heat flow away from the electrode portion 4. The operational life of the discharge lamp 1 is enhanced thereby.

It should be noted that the above-mentioned embodiments illustrate rather than limit the invention, and that those skilled in the art will be able to design many alternative embodiments without departing from the scope of the appended claims. In particular, other shapes for the porous electrode portion 4 are feasible. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. A discharge lamp (1) comprising a sealed bulb (2) accommodating two electrodes (3), wherein at least one of said electrodes has at least a porous portion (4) comprising first particles (10) with a first mean particle size (μ₁) defined by a first particle size distribution (11) and second particles (20) with a second mean particle size (μ₂) defined by a second particle size distribution (21), and wherein said first mean particle size (μ₁) is smaller than said second mean particle size (μ₂).

2. The discharge lamp (1) according to claim 1, wherein said first mean particle size is smaller than said second mean particle size by at least a factor of five, preferably at least a factor of ten.

3. The discharge lamp (1) according to claim 1, wherein said porous portion (4) is formed by a first volume percent of said first particles and a second volume percent of said second particles, and wherein said first volume percent is less than said second volume percent.

4. The discharge lamp (1) according to claim 1, wherein said porous portion (4) has a porosity of between 40 to 50% of the volume of said porous portion.

5. The discharge lamp (1) according to claim 1, wherein said porous portion (4) is provided on a rod (5) of, for example, an ultra high pressure lamp or a high intensity discharge lamp.

6. The discharge lamp (1) according to claim 1, wherein said porous portion (4) is made of reshaped extruded refractory material.

7. A method of manufacturing an electrode portion (4) for a discharge lamp (1), comprising the steps of:
providing a mixture of first particles (10) with a first mean particle size (μ₁) defined by a first particle size distribution (11) and second particles (20) with a second mean particle size (μ₂) defined by a second particle size distribution (21), wherein said first mean particle size (μ₁) is smaller than said second mean particle size (μ₂), and
sintering said mixture so as to obtain said electrode portion (4).

8. The method according to claim 7, wherein said method further comprises the step of providing a smaller volume percentage of said first particles than of said second particles, measured by the volume of said electrode portion.

9. The, method according to claim 7, wherein said method further comprises the steps of providing a rod (5) for said electrode portion (4) and electrically connecting said rod to said electrode portion by sinter shrinking.

10. The method according to claim 7, wherein said method further comprises the steps of
extruding a mixture comprising a binder and said mixture through a die to obtain an extruded product (P);
reshaping said extruded product (P) to obtain an appropriate shape for said electrode portion (4) before sintering.
